(19) United States
(12) Patent Application Publication
(10) Pub. No.: US 2026/0299508 A1
(43) Pub. Date: Oct. 1, 2026

(54) IMAGE FORMING APPARATUS

(71) Applicant: FUJIFILM Business Innovation Corp., Tokyo (JP)

(72) Inventors: Shuhei YAMAZAKI, Kanagawa (JP); Yu Tsuda, Kanagawa (JP); Shinya Makiura, Kanagawa (JP); Motoki Matsushima, Kanagawa (JP)

(73) Assignee: FUJIFILM Business Innovation Corp., Tokyo (JP)

(21) Appl. No.: 19/299,257

(22) Filed: Aug. 13, 2025

(30) Foreign Application Priority Data
Mar. 26, 2025 (JP) 2025-052632

(51) Int. Cl. G03G 21/18; G03G 15/08

(52) U.S. Cl. CPC G03G 21/1807; G03G 15/0875; G03G 2215/068

(57) ABSTRACT

An image forming apparatus includes: plural of toner image forming sections each provided corresponding to each color of a special color, yellow, magenta, cyan, and black, each of which includes a photosensitive body, a development device, a developer accommodation section configured to accommodate a developer to be supplied to the development device, in which the development device develops an electrostatic latent image formed on the photosensitive body to form a toner image in each color; plural of mounting sections each provided corresponding to the toner image forming section of each color, on each of which at least a detachable unit including the developer accommodation section is detachably mounted; a transfer device configured to transfer the toner image in each color developed in the toner image forming section to a recording medium; and a processor configured not to perform an image forming operation in a state in which the detachable unit configured to form a toner image in the special color is not mounted on the mounting section, in a case where a mode is switched from a normal mode in which the toner image forming sections of respective colors are arranged such that the toner image in the special color, a toner image in the yellow, a toner image in the magenta, a toner image in the cyan, and a toner image in the black are superimposed in this order from above on the recording medium, to a base mode in which the detachable unit configured to form the toner image in the special color and the detachable unit configured to form the toner image in the black are replaced with each other and mounted on the mounting sections, and a base is formed in the toner image in the special color on the recording medium having a color other than white.

### CROSS-REFERENCE TO RELATED APPLICATIONS

This application is based on and claims priority under 35 USC 119 from Japanese Patent Application No. 2025-052632 filed Mar. 26, 2025.

### BACKGROUND

### (i) Technical Field

The present invention relates to an image forming apparatus.

### (ii) Related Art

JP2008-020782A discloses a technique relating to an image forming apparatus, such as a copier or a printer, to which an electrophotographic method is applied, more specifically relating to an image forming apparatus that forms an image using a special toner, such as a white toner or a transparent toner, in addition to a black toner and color toners. In the related art, a first toner image forming unit that forms a toner image formed of a toner of a color used for normal image formation, a unit that forms a toner image formed of a special toner, a second toner image forming unit that is interchangeable with a unit that forms a toner image formed of another special toner, an identifying unit that identifies a type of toner used in the second toner image forming unit, and a changing unit that changes an image forming order of the second toner image forming unit with respect to the first toner image forming unit according to a discrimination result of the discrimination unit are provided.

JP2019-015906A discloses a technique relating to an image forming apparatus including a plurality of combinations of an image forming unit that forms a toner image on a toner image carrier, a reservoir that stores a toner for replenishing the image forming unit, and a toner container that accommodates the toner, in which toner images of colors different from each other formed by the combinations are superimposed on a recording member and recorded. In the related art, a configuration is adopted in which, for at least two of the plurality of combinations, an installation positions of the reservoirs are configured to be replaced with each other, and an acquisition unit for acquiring information on the toner stored in each of the reservoirs, and a determination unit for determining whether each of the reservoirs is at a correct installation position based on an acquisition result of the acquisition unit are provided.

### SUMMARY

In an image forming apparatus having a five-color configuration with a special color, yellow, magenta, cyan, and black, toner images of respective colors are usually superimposed in order of the special color, yellow, magenta, cyan, and black from above and transferred to a recording medium to form an image.

However, in a case where an image is formed on a recording medium of a color other than white, such as black, and the toner images of the respective colors are superimposed in the order of the special color, yellow, magenta, cyan, and black and transferred to the recording medium, the tone is changed. Therefore, in a case where the order of the special color and the black is changed and black, yellow, magenta, cyan, and the special color such as white are superimposed in this order from above, and a base is formed on the recording medium having a color other than white with the lowest toner image in the special color, a change in tone is reduced.

However, in a case where an image is erroneously formed even in a state where a toner image in the special color cannot be formed because, for example, a unit for forming a toner image in the special color is not mounted, a base is not formed, and thus a change in tone cannot be reduced.

Aspects of non-limiting embodiments of the present disclosure relate to an image forming apparatus that prevents an image from being formed in a state in which a toner image in a special color cannot be formed in a case where a base is formed with a toner image in the special color on a recording medium having a color other than white.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including: a plurality of toner image forming sections each provided corresponding to each color of a special color, yellow, magenta, cyan, and black, each of which includes a photosensitive body, a development device, a developer accommodation section configured to accommodate a developer to be supplied to the development device, in which the development device develops an electrostatic latent image formed on the photosensitive body to form a toner image in each color; a plurality of mounting sections each provided corresponding to the toner image forming section of each color, on each of which at least a detachable unit including the developer accommodation section is detachably mounted; a transfer device configured to transfer the toner image in each color developed in the toner image forming section to a recording medium; and a processor configured not to perform an image forming operation in a state in which the detachable unit configured to form a toner image in the special color is not mounted on the mounting section, in a case where a mode is switched from a normal mode in which the toner image forming sections of respective colors are arranged such that the toner image in the special color, a toner image in the yellow, a toner image in the magenta, a toner image in the cyan, and a toner image in the black are superimposed in this order from above on the recording medium, to a base mode in which the detachable unit configured to form the toner image in the special color and the detachable unit configured to form the toner image in the black are replaced with each other and mounted on the mounting sections, and a base is formed in the toner image in the special color on the recording medium having a color other than white.

### BRIEF DESCRIPTION OF THE DRAWINGS

Exemplary embodiment(s) of the present invention will be described in detail based on the following figures, wherein:

FIG. 1 is a schematic view showing a configuration of an image forming apparatus in an all-color mode as viewed from a front side in a normal mode;

FIG. 2 is a schematic view showing a configuration in which a monochrome unit is viewed from a front side;

FIG. 3 is a schematic view of a state in which monochrome units are not mounted on all the mounting sections;

FIG. 4 is a schematic view showing a configuration of an image forming apparatus in a four-color mode as viewed from a front side in a normal mode;

FIG. 5 is a schematic view showing a configuration of an image forming apparatus in a monochrome mode as viewed from a front side in a normal mode;

FIG. 6 is a schematic view showing a configuration in which the image forming apparatus in a base mode is viewed from the front side;

FIG. 7 is an explanatory diagram showing replacement between a white monochrome unit and a black monochrome unit;

FIG. 8 is a block diagram showing a hardware configuration of the image forming apparatus; and

FIG. 9 is a flowchart showing a flow of processing of image formation.

### DETAILED DESCRIPTION

Hereinafter, an example of an exemplary embodiment of the present invention will be described with reference to the drawings.

In the following description, a direction denoted by an arrow X in the drawing will be referred to as an apparatus width direction and a direction denoted by an arrow Y will be referred to as an apparatus height direction. In addition, a direction along an arrow Z orthogonal to the apparatus width direction and the apparatus height direction will be referred to as an apparatus depth direction.

Each drawing is shown only schematically. Dimensions, ratios, and the like of respective elements shown in the drawings may not necessarily match actual values. Even between a plurality of drawings, dimensions, ratios, numbers, and the like of respective elements may not necessarily match. In addition, description of configurations and well-known configurations that are not directly related to the present invention may be omitted or simplified.

### Overall Configuration of Image Forming Apparatus

First, an overall configuration of an image forming apparatus will be described.

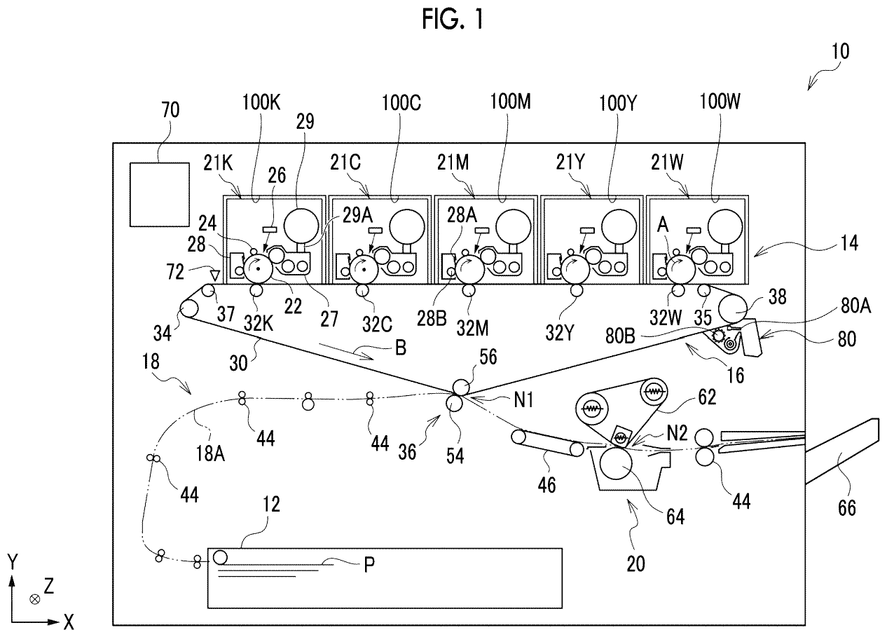

FIG. 1 shows an image forming apparatus 10 according to an exemplary embodiment. The image forming apparatus 10 shown in FIG. 1 is an apparatus that forms an image by an electrophotographic method, and includes a recording medium accommodation section 12, an image forming section 14, a transfer device 16, a recording medium transport device 18, a fixing device 20, and a control section 70.

The recording medium accommodation section 12 has a function of accommodating a sheet material P as an example of the recording medium. Although not shown, the recording medium accommodation section 12 may have a configuration in which a plurality of accommodation sections for accommodating a plurality of types of sheet materials P are provided.

The image forming section 14 has a function of forming a toner image on an intermediate transfer belt 30, which will be described later and which constitutes the transfer device 16, by performing each of processes of charging, exposure, and development. The image forming section 14 includes monochrome units 21Y, 21M, 21C, 21K, and 21W that form a toner image on each photosensitive body 22 using toners of colors different from each other, specifically, yellow (Y), magenta (M), cyan (C), black (K), and white (W).

The monochrome units 21Y, 21M, 21C, 21K, and 21W are examples of a toner image forming section and an example of a detachable unit.

The toners of yellow (Y), magenta (M), cyan (C), and black (K) are examples of a normal-color toner. The toner of white (W) is an example of a special-color toner, and is toner of a color other than yellow (Y), magenta (M), cyan (C), and black (K). Hereinafter, each color may be referred to as a W color, a Y color, an M color, a C color, or a K color.

The monochrome units 21Y, 21M, 21C, 21K, and 21W have the same configurations as each other except for colors of toner images formed by the respective monochrome units. Therefore, hereinafter, in a case where it is not necessary to distinguish the monochrome units 21Y, 21M, 21C, 21K, and 21W and the constituent elements thereof, Y, M, C, K, and W in the monochrome units 21Y, 21M, 21C, 21K, and 21W may be omitted and described as the monochrome unit 21. In addition, Y, M, C, K, and W may be omitted in the same manner for those provided corresponding to Y, M, C, K, and W, respectively.

Since the monochrome units 21 of the respective colors have the same configuration except for the toner used, in each figure, only the monochrome unit 21K is denoted by reference numerals in each portion.

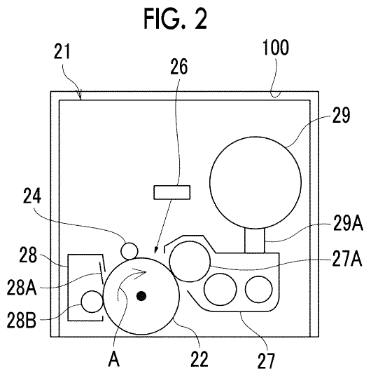

As shown in FIGS. 1 and 2, each monochrome unit 21 includes the photosensitive body 22, a charging roll 24, an exposure device 26, a development device 27, a cleaning device 28, the development device 27, and a developer accommodation section 29. As described above, since the monochrome units 21Y, 21M, 21C, 21K, and 21W have the same configuration except for the colors of the toner images formed by the monochrome units, Y, M, C, K, and W are omitted in FIG. 2.

The photosensitive body 22 rotates in a direction indicated by an arrow A during image formation. The charging roll 24 as an example of a charging device charges a surface of the photosensitive body 22 by applying a voltage, in the present exemplary embodiment, a voltage in which an AC voltage is superimposed on a DC voltage. The exposure device 26 exposes the photosensitive body 22 to form an electrostatic latent image on the photosensitive body 22.

The development device 27 has a developing roll 27A disposed to face the photosensitive body 22. The electrostatic latent image of the photosensitive body 22 is developed by a developer (not shown) held on the developing roll 27A to form a toner image. The developer of the present exemplary embodiment is a two-component developer containing a toner and a carrier. The developer accommodation section 29 accommodates the developer. The developer is supplied from the developer accommodation section 29 to the development device 27 through a supply path 29A.

The cleaning device 28 is disposed on a downstream side of the development device 27 in a rotation direction of the photosensitive body 22 and on a downstream side of a transfer position of the toner image. The cleaning device 28 has a cleaning blade 28A (see FIG. 2) and a cleaning brush 28B (see FIG. 2). The cleaning blade 28A (see FIG. 2) and the cleaning brush 28B (see FIG. 2) remove the toner remaining on the surface of the photosensitive body 22 by the photosensitive body 22 rotating in the direction along the arrow A.

As shown in FIG. 1, the transfer device 16 has a function of holding a toner image of each color formed by each monochrome unit 21 and transferring the toner image to the sheet material P to be transported. The transfer device 16 includes the intermediate transfer belt 30, five transfer rolls 32, a drive roll 38, a secondary transfer section 36, a tension roll 34, surface exposure rolls 35 and 37, and a cleaning device 80.

The intermediate transfer belt 30 has an endless shape. The five transfer rolls 32W, 32Y, 32M, 32C, and 32K as an example of a primary transfer section form a nip with each photosensitive body 22 with the intermediate transfer belt 30 interposed therebetween. The intermediate transfer belt 30 is caused to revolve in a direction along an arrow B by the drive roll 38. The tension roll 34 is pulled to a left side of the drawing, and a tension is applied so that the intermediate transfer belt 30 is not sagged. The surface is exposed by the surface exposure roll 35 and 37 such that the nip is formed between the five transfer rolls 32 and the photosensitive body 22.

In a normal mode described below, the monochrome units 21W, 21Y, 21M, 21C, and 21K are disposed in this order from the upstream side to the downstream side in a revolution direction of the intermediate transfer belt 30. Accordingly, toner images on the photosensitive body 22 that are formed by the monochrome units 21W, 21Y, 21M, 21C, and 21K are transferred to the intermediate transfer belt 30 by the transfer rolls 32 while being superimposed onto each other. The “upstream side of the intermediate transfer belt 30 in the revolution direction” is based on the secondary transfer section 36.

The secondary transfer section 36 includes a transfer roll 54 and an opposing roll 56. The transfer roll 32 is in contact with a surface of the intermediate transfer belt 30 on which the toner image is held. The opposing roll 56 is disposed to face the transfer roll 54 with the intermediate transfer belt 30 interposed therebetween. In the secondary transfer section 36, the toner images of the respective colors held by the intermediate transfer belt 30 are transferred to the sheet material P being transported.

The cleaning device 80 is disposed on a downstream side of the secondary transfer section 36 in the revolution direction of the intermediate transfer belt 30. The cleaning device 80 includes a cleaning blade 80A and a cleaning brush 80B. The cleaning blade 80A has a plate shape, and a tip portion thereof is in contact with the intermediate transfer belt 30. The cleaning brush 80B is in contact with the intermediate transfer belt 30 on an upstream side of the cleaning blade 80A. The cleaning blade 80A and the cleaning brush 80B remove the toner remaining on the intermediate transfer belt 30.

The recording medium transport device 18 has a function of transporting the sheet material P such that the sheet material P passes through a nip N1 of the secondary transfer section 36 and a nip N2 of the fixing device 20. The recording medium transport device 18 includes a plurality of transport rolls 44 and a transport belt 46. Each transport roll 44 is composed of a pair of rolls. The transport roll 44 transports the sheet material P accommodated in the recording medium accommodation section 12 along a transport path 18A.

The transport belt 46 has a configuration in which an endless belt is wound around a pair of rolls disposed to be separated from each other. The transport belt 46 is disposed on a downstream side of the secondary transfer section 36 in a transport direction of the sheet material P and on an upstream side of the fixing device 20. The transport belt 46 transports the sheet material P on which the toner image is transferred by the secondary transfer section 36 to the fixing device 50 along the transport path 18A.

The fixing device 20 has a function of fixing the toner image transferred to the sheet material P by the transfer device 16 in the nip N2. The fixing device 20 includes a heating unit 62 at which an endless belt revolves and a pressurizing roll 64 that comes into pressure-contact with the heating unit 62. The sheet material P is transported through the nip N2 between the heating unit 62 and the pressurizing roll 64, and thus the toner image on the sheet material P is fixed by heating and pressurization.

The control section 70 has a function of controlling each unit of the image forming apparatus 10. For example, the control section 70 controls each unit of the image forming apparatus 10 in accordance with image forming data received from an external apparatus (not shown). Here, the image forming data includes image data such as image information for forming a toner image on each monochrome unit 21, and data required for other image forming operations.

In addition, the image forming apparatus 10 includes a density sensor 72 that detects the density of a toner image transferred to the intermediate transfer belt 30, the density sensor 72 being provided downstream of the monochrome units 21W, 21Y, 21M, 21C, and 21K in the revolution direction of the intermediate transfer belt 30.

### Operation of Image Forming Apparatus

Next, an operation of the image forming apparatus 10 will be described.

The control section 70 that has received the image forming data from an external device (not shown) such as a personal computer operates the image forming section 14, the transfer device 16, the recording medium transport device 18, and the fixing device 20. In the image forming section 14, the photosensitive body 22 are respectively charged by the charging rolls 24 and the photosensitive bodies 22 are respectively exposed to light by the exposure device 26 so that electrostatic latent images attributable to a difference in charging potential are formed on surfaces of each photosensitive body 22. Then, the electrostatic latent image of each photosensitive body 22 is developed as a toner image by each development device 27, and each toner image is formed on the photosensitive body 22.

Next, a primary voltage is applied to each of the transfer rolls 32 from a power source (not shown). In addition, the drive roll 38 driven by a drive source (not shown) causes the intermediate transfer belt 30 to revolve in the direction along the arrow B. As a result, toner images of respective colors are superimposed and subject to primary transfer on the intermediate transfer belt 30.

Furthermore, the recording medium transport device 18 feeds the sheet material P to the nip N1 in accordance with a time at which the toner images of the respective colors held on the revolving intermediate transfer belt 30 reach the nip N1. At the secondary transfer section 36, a secondary transfer voltage is applied from a power source (not shown) to a power supply roll (not shown) that comes into contact with an outer periphery of the opposing roll 56, so that the toner images of the respective colors are secondary-transferred to the sheet material P passing through the nip N1.

Next, the recording medium transport device 18 feeds the sheet material P, onto which the toner images of the respective colors have been secondary-transferred, to the nip N2, so that the toner images of the respective colors are fixed onto the sheet material P passing through the nip N2 by the fixing device 20 and an image is formed on the sheet material P. Thereafter, the sheet material P is discharged to a discharge section 66 by the transport roll 44.

### Monochrome Unit and Mounting Section

The monochrome unit 21 and a mounting section 100 will be described.

As shown in FIGS. 1 and 2, the monochrome units 21W, 21Y, 21M, 21C, and 21K of the respective colors include the photosensitive body 22, the charging roll 24, the exposure device 26, the development device 27, and the cleaning device 28. The monochrome unit 21 of each color is detachably mounted on the mounting section 100. The mounting sections 100W, 100Y, 100M, 100C, and 100K are arranged in this order from the upstream side to the downstream side in the revolution direction of the intermediate transfer belt 30. In the normal mode described below, the monochrome units 21W, 21Y, 21M, 21C, and 21K are detachably mounted on the corresponding mounting sections 100W, 100Y, 100M, 100C, and 100K, respectively.

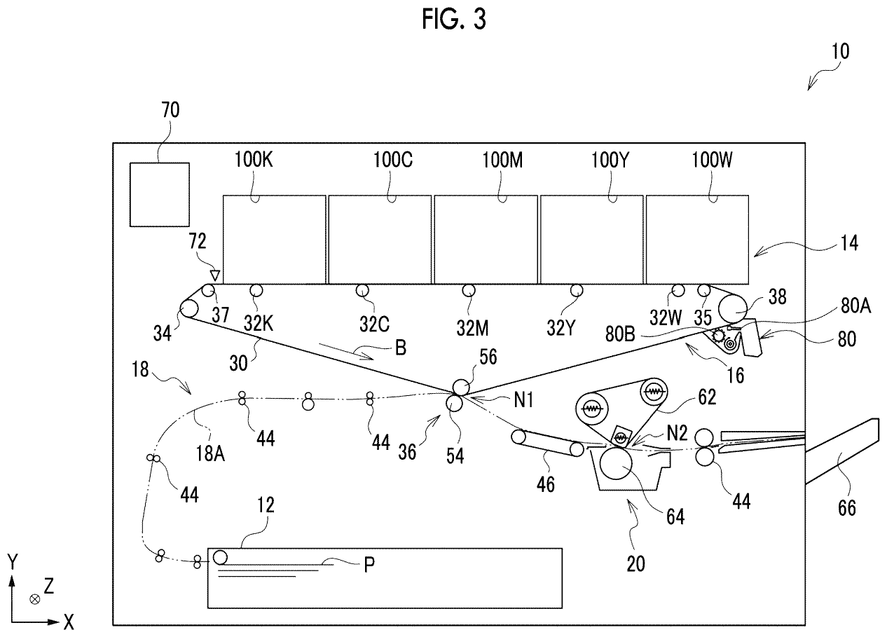

FIG. 3 is a view of a state where none of the monochrome units 21 of the respective colors is mounted on the mounting section 100.

### Roll Movement of Transfer Device

Next, the movement of the roll of the transfer device 16 will be described.

The transfer rolls 32C, 32Y, 32M, and 32W and the surface exposure roll 35 in the transfer device 16 shown in FIG. 1 can be moved downward.

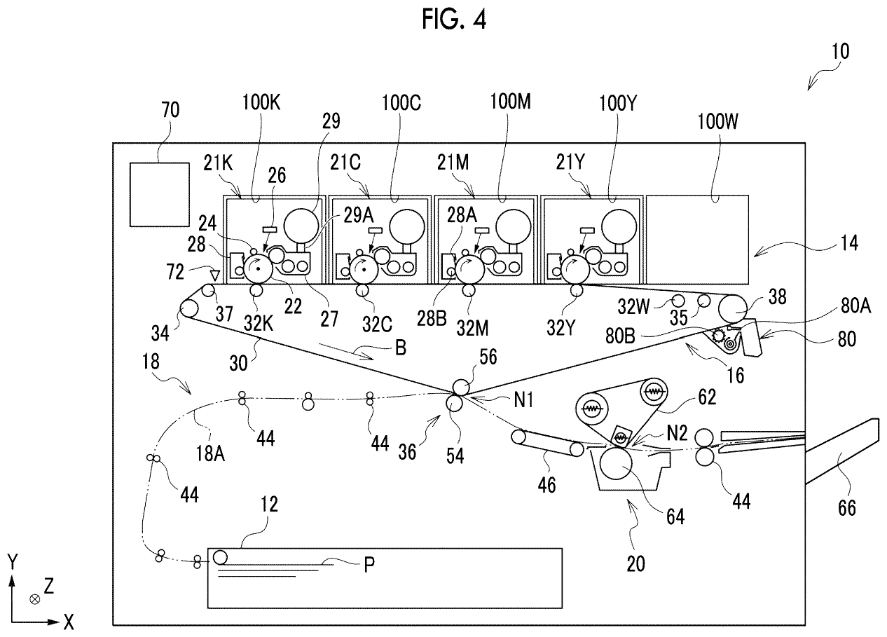

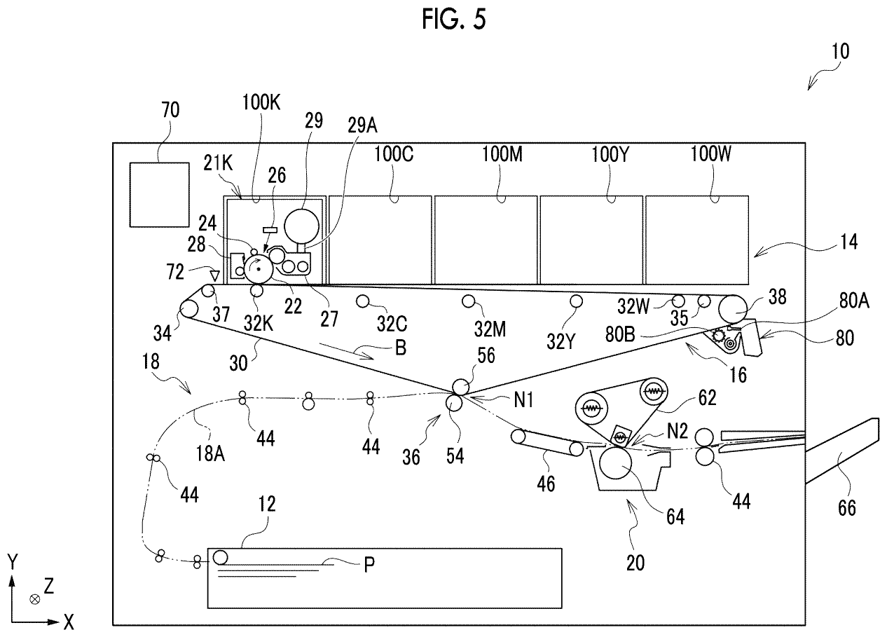

FIG. 4 is a view of a state in which the transfer roll 32W and the surface exposure roll 35 are moved downward. FIG. 5 is a view of a state in which the transfer rolls 32C, 32Y, 32M, and 32W and the surface exposure roll 35 are moved downward. A position before the transfer rolls 32C, 32Y, 32M, and 32C and the surface exposure roll 35 are moved downward is referred to as a normal position, and a position after the transfer rolls 32C, 32Y, 32M, and 32C and the surface exposure roll 35 are moved downward is referred to as a lower position.

### Control Configuration of Image Forming Apparatus

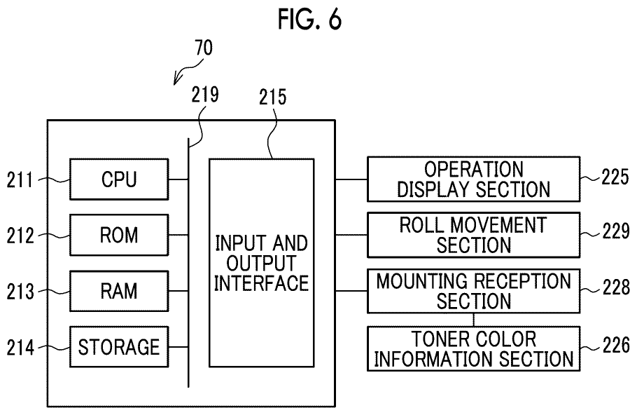

Next, a control configuration that is a configuration of an electric system of the image forming apparatus 10 will be described. FIG. 6 is a block diagram showing a hardware configuration of the image forming apparatus 10.

As shown in FIG. 6, the control section 70 includes a central processing unit (CPU) 211, a read only memory (ROM) 212, a random access memory (RAM) 213, a storage 214, and an input and output interface 215 as components thereof. The components are connected to each other via a bus 219 such that the components can communicate with each other.

The CPU 211 is a central processing unit and executes various programs or controls each unit. The CPU 211 is an example of a processor. The CPU 211 reads out a program from the ROM 212 or the storage 214 and executes the program while using the RAM 213 as a work area. In the present exemplary embodiment, a processing program is stored in the ROM 212 or the storage 214. The CPU 211 performs control and arithmetic processing in accordance with a processing program recorded in the ROM 212 or the storage 214.

The ROM 212 stores various programs and various types of data. The RAM 213 temporarily stores programs or data as a work area. The storage 214 is composed of a hard disk drive (HDD) or a solid state drive (SSD) and stores various programs including an operating system and various types of data.

The input and output interface 215 is an interface for transmission and reception of information to and from a device in the vicinity of the control section 70. The input and output interface 215 is connected to the operation display section 225, the mounting reception section 228, and the roll movement section 229, respectively. Each peripheral device connected to the input and output interface 215 is a representative one, and other devices are also connected.

The operation display section 225 receives an instruction from a user of the image forming apparatus 10. In addition, the operation display section 225 notifies the user of various types of information related to an operation status of the image forming apparatus 10 and the like. The operation display section 225 has, for example, a touch panel type display on which a display button and various types of information are displayed.

The mounting reception section 228 is provided in each of the mounting sections 100 and receives the color information of the toner from a toner color information section 226 in a case where the monochrome unit 21 is mounted. The toner color information section 226 is provided in each of the monochrome units 21 (see FIG. 2), and stores toner color information of the monochrome unit 21. That is, the CPU 211 acquires the toner color information of the toner color information section 226 via mounting reception section 228.

In addition, in a case where the CPU 211 cannot acquire the toner color information from the mounting reception section 228, the CPU 211 determines that the monochrome unit 21 is not mounted on the mounting section 100.

Therefore, the CPU 211 can acquire information on whether the monochrome unit 21 is mounted on each attachment unit 100 and the toner color information of the mounted monochrome unit 21 by using the toner color information section 226 and the mounting reception section 228.

The roll movement section 229 moves the transfer rolls 32C, 32Y, 32M, and 32W and the surface exposure roll 35 (see FIGS. 2, 4, and 5). The roll movement section 229 moves the transfer rolls 32C, 32Y, 32M, and 32W and the surface exposure roll 35 based on an operation command from the CPU 211 in accordance with an all-color mode, a four-color mode, and a monochrome mode, which will be described later (see FIGS. 2, 4, and 5). Even in a case where the transfer rolls 32C, 32Y, 32M, and 32W and the surface exposure roll 35 is move downward, the tension roll 34 pulls the intermediate transfer belt 30, so that the intermediate transfer belt 30 is not bent.

### Image Forming Mode

Next, an image forming mode will be described.

### Normal Mode

The normal mode is a mode in which image formation is performed on the sheet material P in a state in which the monochrome units 21W, 21Y, 21M, 21C, and 21K are mounted on the mounting section 100 in this order from the upstream side to the downstream side in the revolution direction of the intermediate transfer belt 30 as shown in FIG. 1.

Therefore, in the normal mode, a toner image in the W color, a toner image in the Y color, a toner image in the M color, a toner image in the C color, and a toner image in the K color are subject to the primary transfer and superimposed on the intermediate transfer belt 30 in this order from below. In a case where the secondary transfer to the sheet material P is performed, the sheet material P has an image in which the toner image in the W color, the toner image in the Y color, the toner image in the M color, the toner image in the C color, and the toner image in the K color are superimposed in this order from above.

### Base Mode

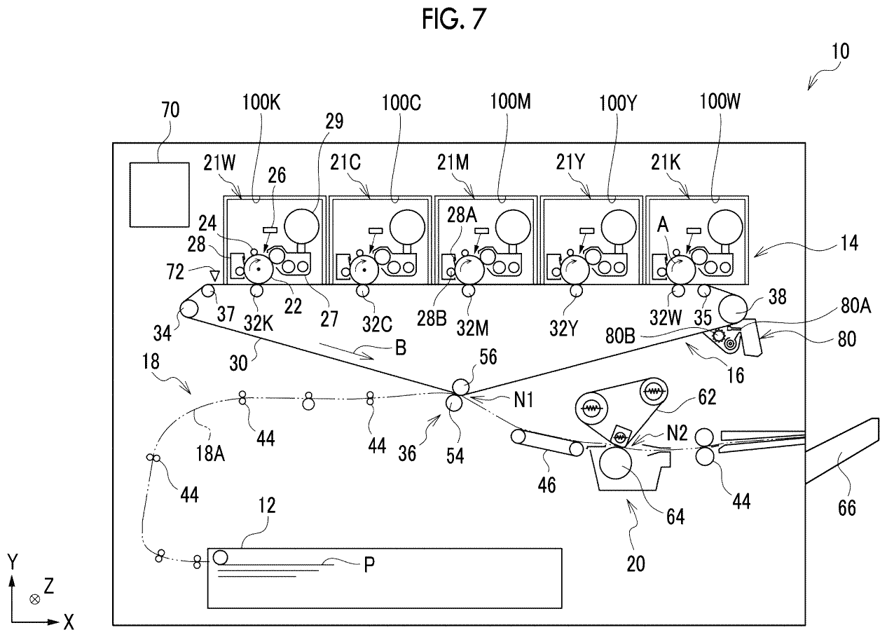

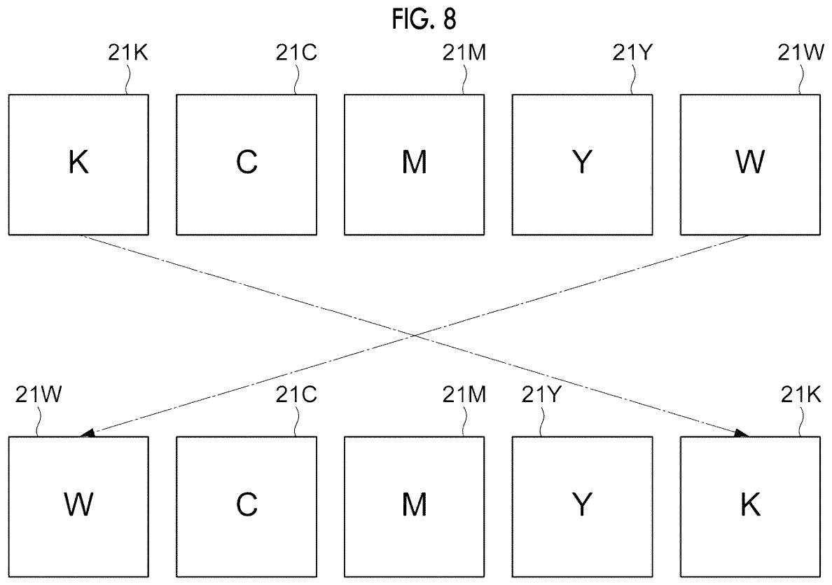

As shown in FIG. 7, the base mode is a mode in which image formation is performed on the sheet material P having a color other than white in a state in which the monochrome units 21K, 21Y, 21M, 21C, and 21W are mounted on the mounting section 100 in this order from the upstream side to the downstream side in the revolution direction of the intermediate transfer belt 30. In other words, the base mode is a mode in which image formation is performed in a state in which the monochrome unit 21K and the monochrome unit 21W in the normal mode are replaced with each other, the monochrome unit 21K is mounted on the mounting section 100W, and the monochrome unit 21W is mounted on the mounting section 100K (see FIG. 8). The “sheet material P having a color other than white” is a colored sheet material P having a color other than white, and does not include a transparent sheet material such as an OHP sheet or a white sheet material.

Therefore, in the base mode, the toner image in the K color, the toner image in the Y color, the toner image in the M color, the toner image in the C color, and the toner image in the W color are subject to the primary transfer and superimposed on the intermediate transfer belt 30 in this order from below. In a case where the secondary transfer to the sheet material P is performed, the sheet material P has an image in which the toner image in the K color, the toner image in the Y color, the toner image in the M color, the toner image in the C color, and the toner image in the W color are superimposed in this order from above.

In a description from another viewpoint, the base mode is a mode in which the base is formed by forming a toner image in the W color on an entire surface of the sheet material P or on substantially the entire surface of the sheet material P excluding an edge portion. It should be noted that, in the present exemplary embodiment as described above, the base is formed on substantially the entire surface of the sheet material P or on substantially the entire surface excluding the edge portion, but the present invention is not limited thereto. For example, the base may be formed only in the region where the image is formed.

In addition, in a case of the base mode, the CPU 211 of the control section 70 form the base by forming the toner image in the W color on the entire surface of the sheet material P or on substantially the entire surface of the sheet material P excluding the edge portion, and forms an image using four colors of the K color, the Y color, the M color, and the C color. In addition, the sheet material P in the base mode is a color other than white, such as black. The sheet material P having a color other than white is accommodated in the recording medium accommodation section 12 (see FIG. 1) by the user.

In FIG. 8, an upper figure is an explanatory view showing an arrangement of the monochrome units 21 in the normal mode, and a lower figure is an explanatory view showing an arrangement of the monochrome units 21 in the base mode. In FIG. 8, intersecting arrows represent the replacement of the monochrome unit 21K and the monochrome unit 21W.

### All-Color Mode

The all-color mode is a mode in which an image can be formed using all five colors in a state shown in FIG. 1 in which the monochrome units 21 are mounted on all the mounting sections 100. In addition, in the all-color mode, all of the transfer rolls 32W, 32Y, 32M, 32C, and 32K and the surface exposure roll 35 of the transfer device 16 are at the normal position above.

### Four-Color Mode

The four-color mode is a mode in which an image can be formed using four colors of the Y color, the M color, the C color, and the K color in a state shown in FIG. 4 in which the monochrome unit 21W is mounted only on the mounting section 100W and the monochrome units 21 are mounted on the other mounting sections 100. In addition, in the four-color mode, the transfer roll 32W and the surface exposure roll 35 of the transfer device 16 are at the lower position where the transfer roll 32W and the surface exposure roll 35 are moved downward, and the transfer rolls 32Y, 32M, 32C, and 32K are at the normal position above.

### Monochrome Mode

The monochrome mode is a mode in which an image can be formed using only the K color in a state shown in FIG. 5 in which only the monochrome unit 21K is mounted on the mounting section 100K and the monochrome units 21 are not mounted on the other mounting sections 100. In addition, in the monochrome mode, only the transfer roll 32K of the transfer device 16 is at the normal position, and the other transfer rolls 32 and the surface exposure roll 35 are at the lower position where the transfer rolls 32 and the surface exposure roll 35 are moved downward.

### Switching of Mode

Next, switching between the modes will be described.

The switching between the normal mode and the base mode is performed by an operation of the user on the operation display section 225 (see FIG. 6) of the image forming apparatus 10 or an operation by an external device (not shown) such as a personal computer.

The CPU 211 (see FIG. 6) of the control section 70 set the all-color mode in a case where the monochrome units 21 are mounted on all the mounting sections 100 in FIG. 1.

In addition, the CPU 211 (see FIG. 6) sets the four-color mode in a case where the monochrome unit 21W is mounted only on the mounting section 100W shown in FIG. 4 and the monochrome units 21 are mounted on the other mounting sections 100.

In addition, the CPU 211 (see FIG. 6) sets the four-color mode in a case where the monochrome unit 21K is mounted only on the mounting section 100K shown in FIG. 5 and the monochrome units 21 are not mounted on the other mounting sections 100.

However, the CPU 211 changes the mode to the all-color mode, the four-color mode, and the monochrome mode only in the normal mode. In addition, in the normal mode, the CPU 211 does not perform the image forming operation in a case other than these states. For example, in a case where the monochrome unit 21Y is not mounted on the mounting section 100Y, the CPU 211 does not perform the image forming operation even in a case where the monochrome units 21 are mounted on other mounting sections 100.

On the other hand, in the base mode, the CPU 211 (see FIG. 6) performs the image forming operation only in a state shown in FIG. 7 in which the monochrome units 21K, 21Y, 21M, 21C, and 21W are mounted on the mounting sections 100 in this order. For example, the CPU 211 (see FIG. 6) does not perform the image forming operation in a state in which the monochrome units 21K, 21Y, 21M, and 21C are mounted and the monochrome unit 21W is not mounted. Alternatively, in a state in which only the monochrome unit 21W is mounted, the image forming operation is not performed. In a description from another viewpoint, in the base mode, the image forming operation is not performed except for the all-color mode in which all the monochrome units 21 are mounted on all the mounting sections 100.

### Flow of Processing

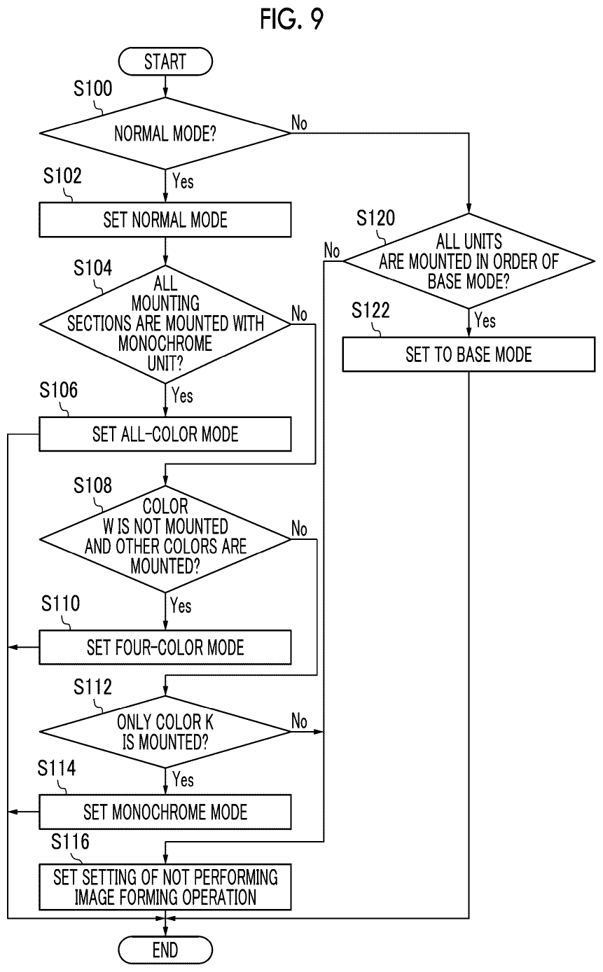

FIG. 9 is a flowchart showing an example of a flow of processing of the image forming operation. In the image forming apparatus 10, the CPU 211 reads out a processing program from the ROM 212 or the storage 214, loads the processing program into the RAM 213, and executes the processing program so that processing is performed.

In step S100, the CPU 211 checks whether the setting of the operation display section 225 is the normal mode. In a case where the mode is the normal mode (YES), the processing proceeds to step S102, and in a case where the mode is not the normal mode (NO), the processing proceeds to step S120.

In step S102, the CPU 211 sets the normal mode. In step S104, the CPU 211 checks whether all the mounting sections 100 are in a state in which the monochrome units 21 are mounted in the normal mode in order. In a case where the monochrome units 21 are mounted, the processing proceeds to step S106. In step S106, the CPU 211 sets the all-color mode. In a case where the monochrome units 21 are not mounted, the processing proceeds to step S108.

In step S108, the CPU 211 checks whether the monochrome unit 21W is not mounted on the mounting section 100W and the monochrome units 21 are mounted on the other mounting sections 100. In a case where the monochrome units 21 are mounted, the processing proceeds to step S110. In step S110, the CPU 211 sets the four-color mode. In a case where the monochrome units 21 are not mounted, the processing proceeds to step S112.

In step S112, the CPU 211 checks whether only the monochrome unit 21K is mounted on the mounting section 100K. In a case where the monochrome unit 21k is mounted (YES), the processing proceeds to step S114. In step S114, the CPU 211 sets the monochrome mode. In a case where the monochrome unit 21k is not mounted (NO), the processing proceeds to step S116. In step S116, the CPU 211 sets the setting of not performing the image forming operation.

In step S120, the CPU checks whether the monochrome units 21K, 21Y, 21M, 21C, and 21W are mounted on the mounting sections 100 in this order. In a case where the monochrome units 21 are mounted (YES), the processing proceeds to step S122. In step S122, the CPU 211 sets the base mode. In a case where the monochrome units 21 are not mounted (NO), the processing proceeds to step S116. As described above, in step S116, the CPU 211 sets the setting of not performing the image forming operation.

### Action

Next, an action of the present exemplary embodiment will be described.

In the image forming apparatus 10, in a case of the base mode in which a base is formed on the sheet material P having a color other than white with the toner image in the W color, the image forming operation is not performed in a state in which the detachable unit of the toner image forming unit of the monochrome unit 21 that forms the toner image in the W color is not attached. Therefore, the image is not formed even in a state in which the toner image in the W color is not formed, that is, even in a state in which the base is not formed. Therefore, a change in tone due to absence of the formation of the base using the toner image in the W color is reduced.

In addition, in a case of the base mode in which the base is formed on the sheet material P having a color other than white with the toner image in the W color, the image forming operation is not performed in a state in which not all the monochrome units 21 are mounted on the mounting sections 100. Therefore, an image is not erroneously formed even in a state in which a toner image of any of the Y color, the M color, the C color, or the K color cannot be formed.

In a case where the monochrome unit 21W of the W color is mounted on the mounting section 100K, the base can be formed. However, since a toner image is not formed in the K color in the four-color mode, there is no demand for image formation. In addition, in the monochrome mode, only the base is formed, and there is no demand for image formation. Therefore, in the present exemplary embodiment, in a case of the base mode, the image forming operation is not performed in a state in which not all the monochrome units 21 are mounted on the mounting sections 100.

In addition, since the base is formed with the toner image in the W color, the change in the tone of the image formed on the base is reduced.

In the present exemplary embodiment, the “setting of not performing the image forming operation” is a setting of stopping the image forming operation. Note that, for example, the setting of not performing the image forming operation may be released by operating the operation display section 225.

### Others

The present invention is not limited to the exemplary embodiment.

For example, in the above-described exemplary embodiment, the base is formed of the toner image in the W color, but the present invention is not limited thereto. The base may have an achromatic color other than the K color, for example, gray or silver.

In addition, for example, in the exemplary embodiment described above, the method of performing the primary transfer of the toner image from the monochrome unit 21 to the intermediate transfer belt 30 and then collectively performing the secondary transfer to the sheet material P is used, but the present disclosure is not limited thereto. A method of sequentially performing the primary transfer of the toner image to the sheet material P to be transported using the monochrome units 21 may be used. In this method, in the normal mode, the monochrome units 21K, 21C, 21M, 21Y, and 21W are arranged in this order from the upstream side in the transport direction of the sheet material P, and in the base mode, the monochrome units 21K, 21C, 21M, 21Y, and 21W are arranged in the reverse order.

In addition, for example, in the exemplary embodiment described above, the monochrome unit 21 is the detachable unit including the photosensitive body 22, the charging roll 24, the exposure device 26, the development device 27, the cleaning device 28, and the developer accommodation section 29, but the present invention is not limited thereto. For example, the detachable unit may be constituted by two components of the development device 27 and the developer accommodation section 29. Alternatively, the detachable unit may be constituted only by the developer accommodation section 29.

In addition, for example, in the exemplary embodiment described above, five colors of the W color, the Y color, the M color, the C color, and the K color are used, but the present invention is not limited thereto. For example, light yellow, light magenta, light cyan, and the like may be further added.

In addition, for example, in the exemplary embodiment described above, the user operates the operation display section 225 to set the setting, but the present invention is not limited thereto. For example, the control section 70 may automatically set the mode as one or both of the monochrome unit 21K and the monochrome unit 21W are mounted on the mounting sections 100K and 100W corresponding to the respective modes.

In addition, the processing in the exemplary embodiment described above can also be realized by a dedicated hardware circuit. In this case, the processing may be executed by a single piece of hardware or may be executed by a plurality of pieces of hardware. Additionally, the program for operation may be provided through a computer-readable recording medium such as a universal serial bus (USB) memory, a flexible disk, or a compact disc read only memory (CD-ROM) or may be provided online via a network such as the Internet. In this case, the program recorded on the computer-readable recording medium is typically transferred to and stored in a memory, a storage, or the like. In addition, for example, the program may be provided as independent application software, or may be incorporated into software of each device as a function of the image forming apparatus 10.

Further, the present invention can be implemented in various ways without departing from the concept of the present invention.

### Supplementary Note

Hereinafter, aspects of the present disclosure will be additionally described.

### (((1)))

An image forming apparatus comprising:
a plurality of toner image forming sections each provided corresponding to each color of a special color, yellow, magenta, cyan, and black, each of which includes a photosensitive body, a development device, a developer accommodation section configured to accommodate a developer to be supplied to the development device, in which the development device develops an electrostatic latent image formed on the photosensitive body to form a toner image in each color;
a plurality of mounting sections each provided corresponding to the toner image forming section of each color, on each of which at least a detachable unit including the developer accommodation section is detachably mounted;
a transfer device configured to transfer the toner image in each color developed in the toner image forming section to a recording medium; and
a processor configured not to perform an image forming operation in a state in which the detachable unit configured to form a toner image in the special color is not mounted on the mounting section, in a case where a mode is switched from a normal mode in which the toner image forming sections of respective colors are arranged such that the toner image in the special color, a toner image in the yellow, a toner image in the magenta, a toner image in the cyan, and a toner image in the black are superimposed in this order from above on the recording medium, to a base mode in which the detachable unit configured to form the toner image in the special color and the detachable unit configured to form the toner image in the black are replaced with each other and mounted on the mounting sections, and a base is formed in the toner image in the special color on the recording medium having a color other than white.

### (((2)))

The image forming apparatus according to (((1))),
wherein the transfer device includes
   an intermediate transfer belt that has a round shape and revolves
   a plurality of primary transfer sections configured to perform primary transfer of the toner images in the respective colors formed by the plurality of toner image forming sections arranged along a revolution direction to the intermediate transfer belt, and
   a second transfer section configured to collectively perform secondary transfer of the toner images in the respective colors transferred to the intermediate transfer belt to the recording medium,
in the normal mode, the toner image forming section configured to form the toner image in the special color, the toner image forming section configured to form the toner image in the yellow, the toner image forming section configured to form the toner image in the magenta, the toner image forming section configured to from the toner image in the cyan, and the toner image forming section configured to form the toner image in the black are mounted in this order from an upstream side of the secondary transfer section, and
in the base mode, the detachable unit configured to form the toner image in the special color and the detachable unit configured to form the toner image in the black are replaced with each other and mounted on the mounting sections.

### (((3)))

The image forming apparatus according to (((1))) or (((2))),
wherein a mode is selectable for the detachable unit from among
   an all-color mode in which all the mounting sections are mounted with the detachable unit, and all the primary transfer sections are in contact with the intermediate transfer belt,
   a four-color mode in which only the mounting section on a most upstream side of the secondary transfer section is not mounted with the detachable unit, and only the primary transfer section on the most upstream side is separated from the intermediate transfer belt, and
   a monochrome mode in which only the mounting section on a most downstream side of the secondary transfer section is mounted with the detachable unit, and only the primary transfer section on the most downstream side is in contact with the intermediate transfer belt, and
the processor is configured not to perform, in the base mode, an image forming operation except for the all-color mode.

### (((4)))

The image forming apparatus according to any one of (((1))) to (((3))),
wherein the special color is an achromatic color other than the black.

### (((5)))

The image forming apparatus according to (((4))),
wherein the special color is the white.

### (((6)))

The image forming apparatus according to (((4))),
wherein the special color is gray.

### (((7)))

The image forming apparatus according to (((4))),
wherein the special color is silver.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a plurality of toner image forming sections each provided corresponding to each color of a special color, yellow, magenta, cyan, and black, each of which includes a photosensitive body, a development device, a developer accommodation section configured to accommodate a developer to be supplied to the development device, in which the development device develops an electrostatic latent image formed on the photosensitive body to form a toner image in each color;
a plurality of mounting sections each provided corresponding to the toner image forming section of each color, on each of which at least a detachable unit including the developer accommodation section is detachably mounted;
a transfer device configured to transfer the toner image in each color developed in the toner image forming section to a recording medium; and
a processor configured not to perform an image forming operation in a state in which the detachable unit configured to form a toner image in the special color is not mounted on the mounting section, in a case where a mode is switched from a normal mode in which the toner image forming sections of respective colors are arranged such that the toner image in the special color, a toner image in the yellow, a toner image in the magenta, a toner image in the cyan, and a toner image in the black are superimposed in this order from above on the recording medium, to a base mode in which the detachable unit configured to form the toner image in the special color and the detachable unit configured to form the toner image in the black are replaced with each other and mounted on the mounting sections, and a base is formed in the toner image in the special color on the recording medium having a color other than white.

2. The image forming apparatus according to claim 1,
wherein the transfer device includes
an intermediate transfer belt that has a round shape and revolves
a plurality of primary transfer sections configured to perform primary transfer of the toner images in the respective colors formed by the plurality of toner image forming sections arranged along a revolution direction to the intermediate transfer belt, and
a second transfer section configured to collectively perform secondary transfer of the toner images in the respective colors transferred to the intermediate transfer belt to the recording medium,
in the normal mode, the toner image forming section configured to form the toner image in the special color, the toner image forming section configured to form the toner image in the yellow, the toner image forming section configured to form the toner image in the magenta, the toner image forming section configured to from the toner image in the cyan, and the toner image forming section configured to form the toner image in the black are mounted in this order from an upstream side of the secondary transfer section, and
in the base mode, the detachable unit configured to form the toner image in the special color and the detachable unit configured to form the toner image in the black are replaced with each other and mounted on the mounting sections.

3. The image forming apparatus according to claim 2,
wherein a mode is selectable for the detachable unit from among
an all-color mode in which all the mounting sections are mounted with the detachable unit, and all the primary transfer sections are in contact with the intermediate transfer belt,
a four-color mode in which only the mounting section on a most upstream side of the secondary transfer section is not mounted with the detachable unit, and only the primary transfer section on the most upstream side is separated from the intermediate transfer belt, and
a monochrome mode in which only the mounting section on a most downstream side of the secondary transfer section is mounted with the detachable unit, and only the primary transfer section on the most downstream side is in contact with the intermediate transfer belt, and
the processor is configured not to perform, in the base mode, an image forming operation except for the all-color mode.

4. The image forming apparatus according to claim 1,
wherein the special color is an achromatic color other than the black.

5. The image forming apparatus according to claim 4,
wherein the special color is the white.

6. The image forming apparatus according to claim 4,
wherein the special color is gray.

7. The image forming apparatus according to claim 4,
wherein the special color is silver.

8. An image forming apparatus comprising:
a plurality of toner image forming sections each provided corresponding to each color of a special color, yellow, magenta, cyan, and black, each of which includes a photosensitive body, a development device, a developer accommodation section configured to accommodate a developer to be supplied to the development device, in which the development device develops an electrostatic latent image formed on the photosensitive body to form a toner image in each color;
a plurality of mounting sections each provided corresponding to the toner image forming section of each color, on each of which at least a detachable unit including the developer accommodation section is detachably mounted;
a transfer device configured to transfer the toner image in each color developed in the toner image forming section to a recording medium; and
means for not performing an image forming operation in a state in which the detachable unit configured to form a toner image in the special color is not mounted on the mounting section, in a case where a mode is switched from a normal mode in which the toner image forming sections of respective colors are arranged such that the toner image in the special color, a toner image in the yellow, a toner image in the magenta, a toner image in the cyan, and a toner image in the black are superimposed in this order from above on the recording medium, to a base mode in which the detachable unit configured to form the toner image in the special color and the detachable unit configured to form the toner image in the black are replaced with each other and mounted on the mounting sections, and a base is formed in the toner image in the special color on the recording medium having a color other than white.
